(19) United States
(12) Patent Application Publication
(10) Pub. No.: US 2026/0180213 A1
(43) Pub. Date: Jun. 25, 2026

(54) INSULATION OF ELECTRICAL CONNECTIONS

(71) Applicant: SCON ENDÜSTRI SANAYI VE TICARET ANONIM SIRKETI, Yunusemre, Manisa (TR)

(72) Inventors: Murat DIKTAS, Yunusemre, Manisa (TR); Nebi Erkan DAL, Yunusemre, Manisa (TR)

(21) Appl. No.: 18/726,263

(22) PCT Filed: Sep. 1, 2023
(86) PCT No.: PCT/TR2023/050900

§ 371 Date: Jul. 2, 2024

(51) Int. Cl. H01R 4/70; H01B 7/282; H01B 13/06

(52) U.S. Cl. CPC H01R 4/70; H01B 7/2825; H01B 13/06

(57) ABSTRACT

Disclosed is an insulation structure for combining electrical connection zones by insulating them against harsh outdoor conditions, providing UV resistance, and providing the sealing requirements of the electrical circuit elements. The insulation structure has an upper polymer part connected to the lower polymer part by ultrasonic welding, closing the electrical element and the connection area from the upper part to fix the electrical element, protect it from external conditions, and provide UV resistance. The lower polymer part is connected to the upper polymer part by ultrasonic welding, closing the electrical element and the connection zone from the upper part to fix the electrical element, protect it from external conditions, and provide UV resistance. Filing material is filled in the gap where the electrical element and the connection zone formed between the lower polymer part and the upper polymer part, and are located to obtain the same level of tightness.

### FIELD OF THE INVENTION

The invention relates to an improved insulation structure designed for combining electrical connections, by insulating them securely against external environmental conditions, in harsh outdoor working conditions, by meeting the UV resistance and sealing requirements of electrical circuit elements such as fuses, branches etc.

### STATE OF THE ART

Solar cables are important components used in solar energy systems. These cables are designed with protection against sunlight and other external factors. Solar cables exposed to sunlight are protected by being covered with a UV resistant outer sheath. This sheath protects the internal structure of the cables from the harmful effects of the sun and ensures a long-lasting performance. Although the cables are manufactured with a protective sheath, the points where they are connected to each other must be further insulated against external environmental conditions. The protection properties of solar cables are crucial so as to improve the efficiency and safety of solar energy systems.

In current applications, the insulation of the combined electrical connections is carried out with the polymer overmold injection method (injection on the part). In this method, plastic overmolding is applied to the contact area of two or more solar cables. In this application, the desired sealing in the combination of the overmold polymer and the cable insulation joint can be achieved by complete fusion between the two materials. However, it is difficult to ensure the continuity of this in every product at the same level and therefore carries a risk. This method also increases the process costs.

One of the studies carried out to insulate electrical connections from external environmental conditions is the invention that is the subject of the utility model application numbered CN218582111. The invention discloses a solar universal coupling belonging to the field of couplings and consisting of a coupling shell, having a coupling cap at one end, a tail end cap and a sleeve at the other end, and a protective device at one end of the tail end cap. According to the solar universal coupling, the connector end of the connecting harness is inserted into the protection chamber of the sealing rubber sleeve through the embodiment of the protection device. The protection chamber protects the connector end of the connection harness, thus reducing the problem of contamination and humidity of the connector end of the connection harness. Another study is the invention subject to patent number KR101020272. A solar light module connection device integrated into a building is provided so as to simply place a strip and a bypass diode without separate operation when the strip and bypass diode are connected to a contact rail. This simplifies the structure and prevents incorrect connection. A distribution cable is connected to both sides of a receptacle. A strip is drawn from a solar light module integrated into a building. The solar module is mounted in the housing. A contact rail electrically connects the strip to a diode and distribution wire. The contact rail comprises a curvature part and a bent part. An elastic band connector consists of an expanding piece, a snug-fitting piece, and an elongating piece.

As a result, the requirement for an insulation structure which eliminates the abovementioned problems and the insufficiency of the current solutions makes it necessary to make a development in the relevant technical field.

### BRIEF DESCRIPTION OF THE INVENTION

The present invention relates to an improved insulation structure designed for combining electrical connections, by insulating them securely against external environmental conditions, in harsh outdoor working conditions, by meeting the UV resistance and sealing requirements of electrical circuit elements such as fuses etc, which meets the above-mentioned requirements, eliminates all disadvantages and brings some additional advantages.

The aim of the present invention in the insulation structure developed based on the known state of the art is to ensure that the tightness is obtained at the same level continuously as a result of the fluid filling material fully grasping the components by spreading and full adhesion (adherence) on the components, after joining the connection area or electrical element, two-part polymer parts with ultrasonic welding technology, filling the inner cavity with fluid filling material.

The aim of the present invention is to prevent interference from external factors after the filling process by combining the outer cover with ultrasonic welding technology.

Another aim of the present invention is to provide heat discharge in case of possible heating of the connection area or electrical element simultaneously, with the help of the applied filling material.

Another aim of the present invention is to ensure the continuity and durability of the cable fixation with the presence of at least one notch structure in the cable throat part of the two-piece polymer part.

The structural and characteristic features of the present invention will be understood clearly by the following drawings and the detailed description made with reference to these drawings and therefore the evaluation shall be made by taking these figures and the detailed description into consideration.

### BRIEF DESCRIPTION OF DRAWINGS

In order to understand the advantages of the present invention with its structure and additional elements, it shall be evaluated with the following defined figures.

FIG. 1; is the schematic overview of the disassembled state of the insulation structure,

FIG. 2; is the schematic overview of the polymer cap,

FIG. 3; is the schematic overview of the upper polymer part,

FIG. 4; is the schematic overview of the lower polymer part,

FIG. 5; is the schematic general view of the disassembled section of the insulation structure.

### REFERENCE NUMBERS

100. Insulation structure
110. Polymer cap
111. Notch
120. Upper polymer part
121. First notch
122. Second notch
130. Lower polymer part
131. Fixing notch
132. Weld notch
140. Filling material
200. Electrical element
210. Connection zone

### DETAILED DESCRIPTION OF THE INVENTION

In this detailed description, the inventive insulation structure (100) designed for combining electrical connection zones (210), by insulating them securely against external environmental conditions, in harsh outdoor working conditions, by meeting the UV resistance and sealing requirements of electrical circuit elements (200) such as fuses and etc, is explained only as an example for a better understanding of the subject and in a way that does not create any limiting effect.

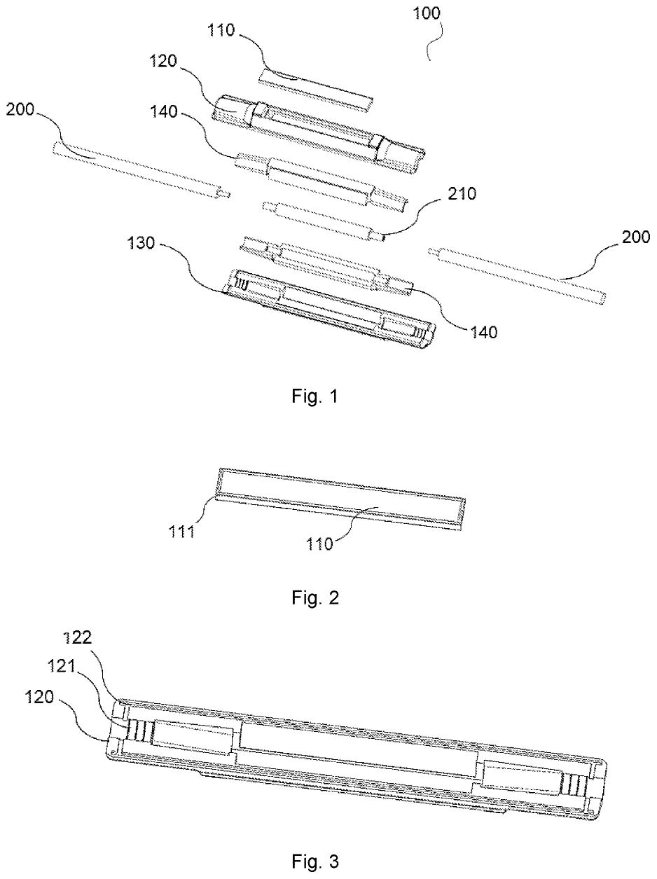

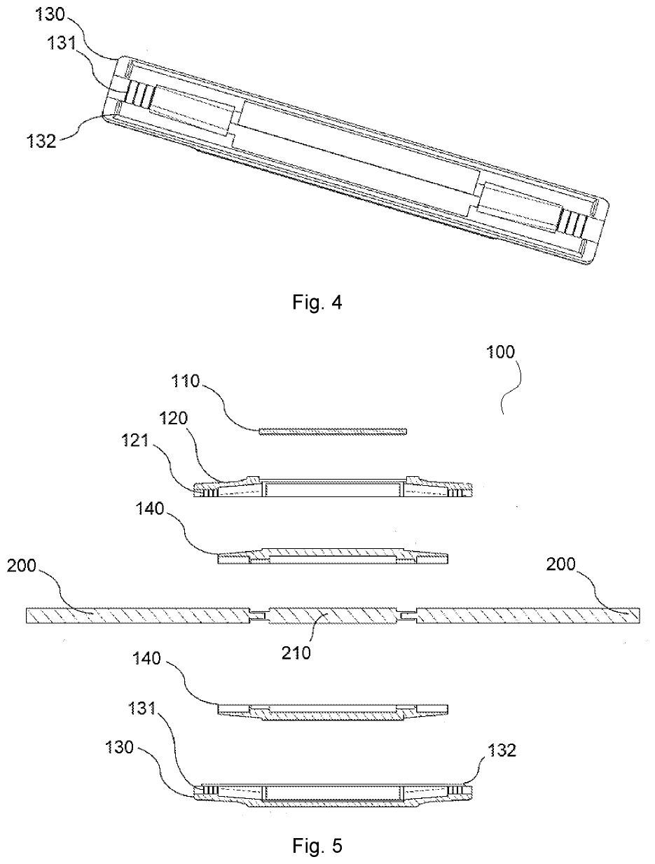

The inventive insulation structure (100) is characterized by obtaining high protection against outdoor conditions with UV resistance and the same level of sealing continuously with fluid filling material (140), which is filled into the space where the connection zone (210) is located after joining the lower polymer part (130) and the upper polymer part (120) by ultrasonic welding method. The insulation structure (100) shown in FIG. 1 comprises; polymer cap (110) placed on the upper polymer part (120) to protect the connection zones (210) of the electrical elements (200) (cable) from external environmental conditions and to provide UV resistance; upper polymer part (120), which is connected to the lower polymer part (130) by closing the electrical element (200) and the connection zone (210) from its upper part, in order to fix the electrical element (200) and to protect it from external environmental conditions and to provide UV resistance; lower polymer part (130) that is connected to the upper polymer part (120) by closing the electrical element (200) and the connection area (210) from the lower part in order to fix the electrical element (200) and to protect it from external environmental conditions and to provide UV resistance; filling material (140) filled in the gap where the electrical element (200) and the connection region (210) formed between the lower polymer part (120) and the upper polymer part (130) are located so as to obtain the same level of tightness at all times. The polymer cap (110) shown in FIG. 2 has a notch (111) on the inside to fully bond to the upper polymer part (120) by ultrasonic welding. There is a first notch (121) at the end of the cavity inside the upper polymer part (120) shown in FIG. 3 so as to ensure the continuity and durability of the fixing of the electrical element (200) to the lower polymer part (130) and the upper polymer part (120), as well as the sealing of this region. There is a second notch (122) positioned around the first notch (121) in order to fully join this lower polymer part (130) and the upper polymer part (120) by ultrasonic welding. There is a fixing notch (131) at the end of the cavity inside the upper polymer part (120) shown in FIG. 4 so as to ensure the continuity and durability of the fixing of the electrical element (200) to the lower polymer part (130) and the upper polymer part (120), as well as the sealing of this region. There is a weld notch (132) positioned around said fixing notch (131) in order to fully join this lower polymer part (130) and the upper polymer part (120) by ultrasonic welding.

The lower polymer part (130) and the upper polymer part (120) of the two-piece insulation structure (100) are joined by ultrasonic welding technology with the help of the second notch (122) and weld notch (132) on them so as to fix the connection zone (210) or electrical element (200) shown in FIG. 5 and to protect it from external factors, especially UV. At least one first notch (121) and fixing notch (131) structure located in the lower polymer part (130) and the electrical element (200) located in the middle part of the upper polymer part (120) in a combination, provide better adhesion of the lower polymer part (130) and the upper polymer part (120) by sinking into the insulation on the electrical element (200), and also contribute to the sealing. After the two-piece lower polymer part (130) and the upper polymer part (120) are combined, a fluid filling material (140) that provides full coverage is applied to the inner part, ensuring that the sealing is continuously at the same level. The filling material (140) simultaneously provides heat discharge in case of possible heating of the connection zone (210) or the electrical element (200). After the filling process is completed, the polymer cap part (110) is combined with the upper polymer part (120) by ultrasonic welding technology, with the help of the notch (111) thereon, in order to prevent interference from external factors.

1. An insulation structure for combining electrical connection zones by insulating them against external environmental conditions, in harsh outdoor working conditions, by meeting the UV resistance and sealing requirements of electrical circuit elements such as fuses and the like, the insulation structure comprising;
an upper polymer part which is connected to a lower polymer part by ultrasonic welding by closing the electrical element and the connection zone from the upper part, in order to fix the electrical element and to protect it from external environmental conditions and to provide UV resistance;
a lower polymer part which is connected to the upper polymer part by ultrasonic welding by closing the electrical element and the connection zone from the upper part, in order to fix the electrical element and to protect it from external environmental conditions and to provide UV resistance; and
a filling material filled in the gap where the electrical element and the connection zone formed between the lower polymer part and the upper polymer part are located so as to obtain the same level of tightness at all times.

2. The insulation structure according to claim 1, further comprising; a notch positioned inside a polymer cap for full engagement with the upper polymer part by ultrasonic welding.

3. The insulation structure according to claim 1, further comprising; at least one first notch located in the electrical element placement region in the middle part of the upper polymer part so as to ensure the continuity, durability and sealing of the electrical element in the fastening of the lower polymer part and the upper polymer part.

4. The insulation structure according to claim 3, further comprising; a second notch positioned around the first notch in order to fully join this the lower polymer part and the upper polymer part by ultrasonic welding.

5. The insulation structure according to claim 1, further comprising; at least one fixing notch located in the electrical element placement area in the middle part of the lower polymer part so as to ensure the continuity, durability and sealing of the electrical element to the lower polymer part and the upper polymer part.

6. The insulation structure according to claim 51, further comprising; a welding notch positioned around the at least one fixing notch in order to fully join the lower polymer part and the upper polymer part by ultrasonic welding.

7. The insulation structure according to claim 1, further comprising; a polymer cap placed on the upper polymer part to protect the connection zones of the electrical elements from external environmental conditions and to provide UV resistance.

8. The insulation structure according to claim 1, wherein the filling material is fluid.
